(19) United States
(12) Patent Application Publication
(10) Pub. No.: US 2009/0204318 A1
(43) Pub. Date: Aug. 13, 2009

(54) METHOD FOR CHECKING THE PLAUSIBILITY OF AN ASCERTAINED VEHICLE MASS

(76) Inventors: Matthew Nimmo, Ludwigsburg (DE); Laszlo Boros, Korntal-Muenchingen (DE); Michael Wommer, Nordheim/Nordhausen (DE)

Correspondence Address: KENYON & KENYON LLP, ONE BROADWAY, NEW YORK, NY, 10004, US

(21) Appl. No.: 12/158,353

(22) PCT Filed: Nov. 15, 2006
(86) PCT No.: PCT/EP2006/068486

§ 371 Date: Oct. 27, 2008

(30) Foreign Application Priority Data
Dec. 20, 2005 (DE) 10 2005 060 857.4

(51) Int. Cl. G01G 19/08

(52) U.S. Cl. 701/124

(57) ABSTRACT

In a method for detecting the loading state of a motor vehicle, first wheel loads of all wheels are ascertained in the absence of cornering, second wheel loads of at least the rear wheel which is on the inside of the curve and of the front wheel which is on the inside of the curve are ascertained when cornering, and information relating to the loading state of the motor vehicle is ascertained on the basis of the first and second wheel loads of the wheels which are on the inside of the curve.

### FIELD OF THE INVENTION

The invention relates to a method for detecting the loading state of a motor vehicle.

### BACKGROUND INFORMATION

The driving performance of a vehicle relating for example to longitudinal or transverse dynamics is influenced materially by its mass and the position of its center of gravity. For example, the ideal distribution of braking force depends materially on the particular axle loads.

In the case of vehicles with a large possible payload, the gross weight of the vehicle may double due to the payload. At the same time, the position of the center of gravity in the longitudinal direction may shift by tens of centimeters in the direction of the rear axle. The performance of vehicle dynamics regulators and wheel slip regulators is influenced by the difference in gross weight. For example, a loaded vehicle needs a much greater driving torque to achieve satisfactory acceleration. At the same time, the loaded drive axle can put out much greater driving torque without running the danger that the driven wheel will be driven with excessively high drive slip.

Conventional arrangements for estimating the mass have the disadvantage that they react relatively sensitively to malfunctions or changes in the input signals and system parameters.

Since the lack of precision is anchored already in the underlying model, the estimated mass cannot readily be recognized as erroneous through the model alone. Depending on the implementation, the estimation of mass may be parameterized in such a way that it is only activated when certain longitudinal acceleration and/or force thresholds are exceeded. In this manner, it is possible to maintain the precision of the estimate of mass despite the aforementioned disturbance variables. The availability of the estimate then decreases, however, since the events in which estimating is permitted decrease as the demand for precision increases.

A method and a device for computer-assisted estimation of the mass of a vehicle are described in German Published Patent Application No. 103 07 511. The estimate is based on the equilibrium relationship between the propulsive force F and the sum of the inertial force and the resistances to propulsion, which include the values of the mass m and the gradient angle of the roadway.

### SUMMARY

Example embodiments of the present invention provide a method for detecting the loading state of a motor vehicle, in which
first wheel loads of all wheels, or at least of the rear wheel which will later be on the inside of the curve and of the front wheel which will later be on the inside of the curve, are ascertained in the absence of cornering,
second wheel loads of at least the rear wheel which is on the inside of the curve and of the front wheel which is on the inside of the curve are ascertained when cornering, and
information relating to the loading state of the motor vehicle is ascertained on the basis of the first and second wheel loads. That makes it possible to easily obtain loading information which may be used for example to check the plausibility of an estimate of mass.

An example embodiment of the present invention is characterized in that the purpose of the information relating to the loading state is to determine whether the vehicle is unloaded or loaded. This information alone enables a rough plausibility check of an estimate of mass.

An example embodiment of the present invention is characterized in that the vehicle is detected as unloaded if
the second wheel load of the front wheel on the inside of the curve is less than the first wheel load of the front wheel on the inside of the curve by a first amount, and
the second wheel load of the rear wheel on the inside of the curve is less than the first wheel load of the rear wheel on the inside of the curve by a second amount,
the second amount being greater than the first amount.

An example embodiment of the present invention is characterized in that the vehicle is detected as unloaded if
the second wheel load of the front wheel on the inside of the curve is only slightly less than the first wheel load of the front wheel on the inside of the curve, and
the second wheel load of the rear wheel on the inside of the curve is substantially less than the first wheel load of the rear wheel on the inside of the curve.

An example embodiment of the present invention is characterized in that the vehicle is detected as loaded if
the second wheel load of the front wheel on the inside of the curve is less than the first wheel load of the front wheel on the inside of the curve by a first amount, and
the second wheel load of the rear wheel on the inside of the curve is less than the first wheel load of the rear wheel on the inside of the curve by a second amount,
the second amount being smaller than the first amount.

An example embodiment of the present invention is characterized in that the vehicle is detected as loaded if
the second wheel load of the front wheel on the inside of the curve is substantially less than the first wheel load of the front wheel on the inside of the curve, and
the second wheel load of the rear wheel on the inside of the curve is only slightly less than the first wheel load of the rear wheel on the inside of the curve.

An example embodiment of the present invention is characterized in that the determination of the first wheel loads and of the second wheel loads is done in such a way that the loading or load distribution of the vehicle does not change between the two determinations.

An example embodiment of the present invention is characterized in that the wheel loads are ascertained from the longitudinal tire force and the coefficient of friction of the contact between tire and roadway.

An example embodiment of the present invention is characterized in that
in addition, the wheel loads on the rear axle are compared to the wheel loads on the front axle, and
in the event that the wheel loads on the rear axle are significantly higher than the wheel loads on the front axle, the vehicle is detected as loaded.

For example, if the difference between the sum of the wheel loads on the rear axle and the sum of the wheel loads on the front axle exceeds a defined threshold value, then the vehicle is detected as loaded.

In addition, example embodiments of the present invention provide a device that is arranged for carrying out the methods described above.

The example embodiments of the method are also manifested as example embodiments of the device, and vice versa.

### BRIEF DESCRIPTION OF THE DRAWINGS

FIG. 1 shows the μ-slip curve.

FIG. 2 shows, in the form of a block diagram, the use of example embodiments of the present invention to check the plausibility of an estimate of mass.

FIG. 3 shows the sequence of the method according to an example embodiment of the present invention.

### DETAILED DESCRIPTION

An aspect of example embodiments of the present invention is based on the fact that a payload added to the vehicle is reflected in changed wheel loads. Conversely, conclusions about the loading may be drawn from the static and dynamic wheel loads. The wheel loads may be calculated from the slippage response of the wheel to a known longitudinal tire force. The calculation of the wheel loads depends on certain parameters that will be stated later (for example, the longitudinal stiffness of the tires). Since some of these parameters may change during operation of the vehicle and could result in a corresponding error in calculating the wheel load, it makes sense to examine how the changes in wheel load relate to each other. If one assumes that although the parameters are largely unknown they are of equal magnitude on all four wheels, these parameters cancel each other out and no longer represent a source of errors.

It is possible from the comparison of the static wheel loads with each other to draw conclusions for example about the present position of the center of gravity, in particular along the longitudinal axis.

A conclusion about the instantaneous loading is possible for example from the shift of the center of gravity compared to the unloaded vehicle.

For example, a typical van has its center of gravity more or less at the halfway point of the distance between the front and rear axles. In addition, the loading area is typically in the rear part of the vehicle. If the vehicle is loaded, the center of the total mass shifts in the direction of the rear axle. The wheel loads on the rear axle increase more than those on the front axle. By evaluating the particular wheel behavior and by comparing the wheels with each other it is possible to recognize the shift of the center of gravity and to deduce the presence of a load.

The results of the estimate of the position of the center of gravity or of the analysis of wheel dynamics do not always permit unambiguous conclusions to be drawn about the loading state. If the position of the center of gravity does not change, for example, it is not necessarily possible to conclude that the vehicle is unloaded; after all, it would be possible that the vehicle was loaded precisely at the center of gravity of the vehicle. But on the other hand, a significant shift of the center of gravity in the direction of the rear axle points clearly to an increased load. The unambiguity of the statement depends in significant measure on the vehicle geometry, in particular the position and dimensions of the load area. Because of these limitations, the example embodiments of the present invention described herein do not replace an explicit estimate of mass, but it serves in a constructive manner in checking the plausibility of the results of existing mass algorithms.

Along with the evaluation of the static wheel loads, the dynamic wheel loads are also suitable for determining the position of the center of gravity. For example, it is possible to observe that, during mild to moderate cornering with the vehicle unloaded, the rear wheel on the inside of the curve is relieved of much of its load or even lifted, whereas the front wheel on the inside of the curve is relieved much less. With the vehicle loaded, on the other hand, the behavior may be exactly the opposite:

the rear wheel on the inside of the curve is barely relieved, whereas the front wheel on the inside of the curve is greatly relieved. This behavior can be explained by the vertical center of gravity, which is distributed over both axes. The back of the unloaded vehicle has a relatively high center of gravity, which makes for high dynamic wheel loads even at moderate lateral accelerations. That the vehicle does not tip over is due to the fact that the front part of the vehicle provides for adequate roll stability due to its typically low center of gravity. The lowering of the center of gravity at the rear axle leads to the conclusion that the vehicle is loaded.

Individual wheel loads can be calculated by means of two basic formulas. For a given coefficient of friction and longitudinal tire force Fb, the wheel load FN is calculated as follows:

FN=Fb/μ.

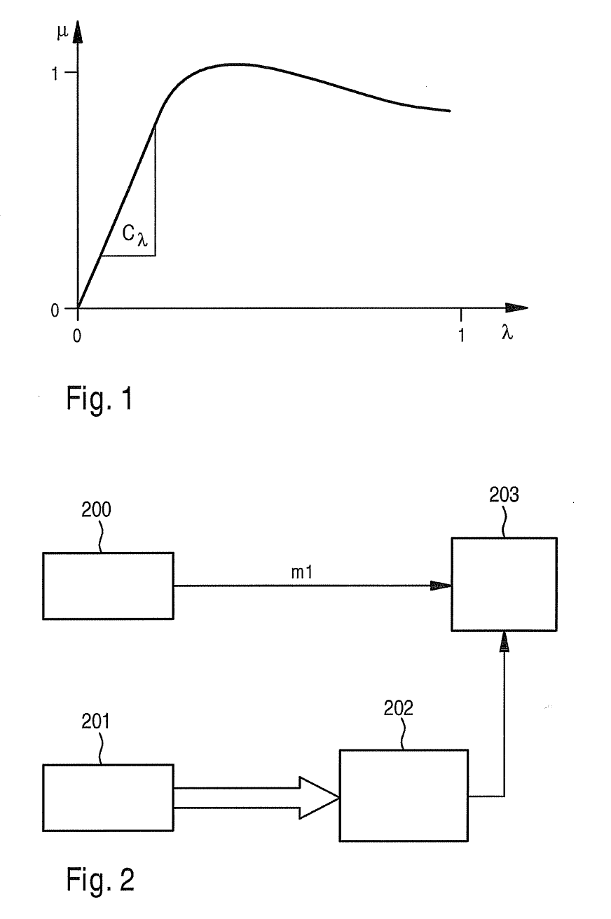

The instantaneous coefficient of friction μ results from the so-called μ-slip curve of the tire, which is depicted in FIG. 1. In this depiction the wheel slip λ is plotted in the direction of the abscissa and the coefficient of friction μ in the direction of the ordinate.

In the linear arm of the curve (left area), for a known longitudinal slip λ and known longitudinal tire stiffness C the coefficient of friction μ is calculated as follows:

μ=C*λ

The longitudinal tire force Fb can be calculated from the driving torque during propulsion and from the braking force when braking. The longitudinal tire slip λ results from the measured wheel rotational speed and the vehicle velocity. The longitudinal tire stiffness C is a tire-dependent characteristic.

The named relationships yield the result of the wheel load analysis, either directly from analysis as the longitudinal displacement or through heuristic evaluation of the input signals (“lifting of rear wheel on inside of curve during mild cornering”) and outputting of a probability of loading (“vehicle unloaded”).

The particular result from the analysis of the static and dynamic changes in wheel load will now be used in accordance with the possible conclusion to check the plausibility of an estimate of mass. This plausibility check may be performed through upper and lower boundaries of the estimated mass.

For example, if a shift of the center of gravity is detected, the conclusion is: “the vehicle is not unloaded.” A plausibility check might be performed to the effect that a lower minimum boundary for the estimated mass is raised to a plausible value, for example corresponding to a partially loaded vehicle. An estimate of mass for the vehicle takes place in Block 200 in FIG. 2. The mass of the vehicle m1 is ascertained using this estimate of mass. In Block 201 an analysis of the wheel loads occurs. Using these wheel loads, in Block 202 additional information about the mass is obtained. This may be for example information about whether the vehicle is loaded or unloaded. On the basis of this information about the mass, in Block 203 a check is performed of whether or not the vehicle mass ascertained in Block 200 is plausible.

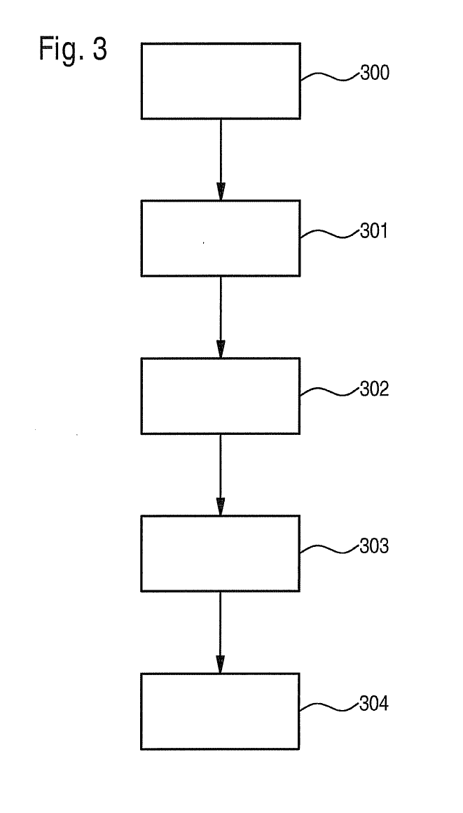

The sequence of the method is depicted in FIG. 3. After the method for detecting the loading state of a motor vehicle starts in Block 300, in Block 301 first wheel loads at least of the rear wheel on the inside of the curve and of the front wheel on the inside of the curve are ascertained in the absence of cornering. Next, in Block 302 second wheel loads of at least the rear wheel which is on the inside of the curve and of the front wheel which is on the inside of the curve are ascertained when cornering. Information relating to the loading state of the motor vehicle is ascertained in Block 303 on the basis of the first and second wheel loads. The method ends in Block 304.

1-10. (canceled)

11. A method for detecting a loading state of a motor vehicle, comprising:
ascertaining first wheel loads of all wheels in an absence of cornering;
ascertaining second wheel loads of at least a rear wheel which is on an inside of a curve and of a front wheel which is on the inside of the curve when cornering; and
ascertaining information relating to the loading state of the motor vehicle based on the first wheel load and the second wheel load of the wheels on the inside of the curve.

12. The method according to claim 11, wherein the information relating to the loading state determines whether the vehicle is unloaded or loaded.

13. The method according to claim 12, wherein the vehicle is detected as unloaded if:
the second wheel load of the front wheel on the inside of the curve is less than the first wheel load of the front wheel on the inside of the curve by a first amount;
the second wheel load of the rear wheel on the inside of the curve is less than the first wheel load of the rear wheel on the inside of the curve by a second amount; and
the second amount is greater than the first amount.

14. The method according to claim 13, wherein the vehicle is detected as unloaded if:
the second wheel load of the front wheel on the inside of the curve is only slightly less than the first wheel load of the front wheel on the inside of the curve; and
the second wheel load of the rear wheel on the inside of the curve is substantially less than the first wheel load of the rear wheel on the inside of the curve.

15. The method according to claim 12, wherein the vehicle is detected as unloaded if:
the second wheel load of the front wheel on the inside of the curve is less than the first wheel load of the front wheel on the inside of the curve by a first amount; and
the second wheel load of the rear wheel on the inside of the curve is less than the first wheel load of the rear wheel on the inside of the curve by a second amount; and
the second amount is smaller than the first amount.

16. The method according to claim 15, wherein the vehicle is detected as loaded if:
the second wheel load of the front wheel on the inside of the curve is substantially less than the first wheel load of the front wheel on the inside of the curve; and
the second wheel load of the rear wheel on the inside of the curve is only slightly less than the first wheel load of the rear wheel on the inside of the curve.

17. The method according to claim 11, wherein the determination of the first wheel loads and of the second wheel loads is done such that a loading or load distribution of the vehicle does not change between the two determinations.

18. The method according to claim 11, wherein the wheel loads are ascertained from a longitudinal tire force and a coefficient of friction of a contact between a tire and a roadway.

19. The method according to claim 11, wherein the wheel loads on a rear axle are compared to the wheel loads on a front axle, and in the event that the wheel loads at the rear axle are significantly higher than the wheel loads at the front axle, the vehicle is detected as being loaded.

20. A device for detecting a loading state of a motor vehicle, comprising:
an arrangement configured to ascertain first wheel loads of all wheels in an absence of cornering;
an arrangement configured to ascertain second wheel loads of at least a rear wheel which is on an inside of a curve and of a front wheel which is on the inside of the curve when cornering; and
an arrangement configured to ascertain information relating to the loading state of the motor vehicle based on the first wheel load and the second wheel load of the wheels on the inside of the curve.

21. A device for detecting a loading state of a motor vehicle, comprising:
means for ascertaining first wheel loads of all wheels in an absence of cornering;
means for ascertaining second wheel loads of at least a rear wheel which is on an inside of a curve and of a front wheel which is on the inside of the curve when cornering; and
means for ascertaining information relating to the loading state of the motor vehicle based on the first wheel load and the second wheel load of the wheels on the inside of the curve.
